(19) United States
(12) Patent Application Publication
(10) Pub. No.: US 2026/0365359 A1
(43) Pub. Date: Nov. 19, 2026

(54) APPARATUS AND METHOD FOR SIZING A BOX CONTAINING ONE OR MORE OBJECTS TO BE PACKAGED

(71) Applicant: I.M.A. INDUSTRIA MACCHINE AUTOMATICHE S.P.A., OZZANO DELL'EMILIA (BO) (IT)

(72) Inventors: Dario REA, OZZANO DELL'EMILIA (BO) (IT); Alessandro CARAPIA, OZZANO DELL'EMILIA (BO) (IT); Massimiliano MINARELLI, OZZANO DELL'EMILIA (BO) (IT)

(21) Appl. No.: 19/148,042

(22) PCT Filed: Jan. 15, 2024
(86) PCT No.: PCT/IT2024/050006

§ 371 Date: Jul. 15, 2025

(30) Foreign Application Priority Data
Jan. 16, 2023 (IT) 102023000000447

(51) Int. Cl. B65B 59/00; B65B 59/02; B65B 61/00; B65B 61/02

(52) U.S. Cl. CPC B65B 59/001; B65B 59/02; B65B 61/005; B65B 61/02

(57) ABSTRACT

Apparatus (10) for sizing a box (100) having lateral walls (102, 103, 104, 105) delimited by vertical edges (106) and a horizontal base wall (101), and containing one or more objects. The apparatus (10) comprises a first frame (11), which is provided with a base (14) configured to support a box (100), a resizing unit (15) comprising a second frame (16) configured to support a cutting and creasing unit (17) which comprises at least one cutting and creasing device (30a) having both a cutting member (32) and also a creasing member (33) which can be activated in a coordinated manner with each other.

### FIELD OF THE INVENTION

The present invention concerns an apparatus and a method for sizing a box containing objects of different kinds and sizes, in order to resize it as a function of the overall dimensions of the objects present in it. The present invention can be applied, for example, without limitation to generality, to packaging objects purchased in the context of electronic commerce (e-commerce).

### BACKGROUND OF THE INVENTION

In the context of plants for packaging and shipping objects that derive, for example, from online purchase orders, the objects associated with a given purchase order are placed into empty boxes, which are closed on them, packaging them, to then proceed with the shipment of the package to the desired address.

Normally, since each purchase order can concern various objects having different shapes, weights and sizes, the respective box has to also be chosen appropriately, so that it is as small as possible, yet still able to contain all the objects associated with the respective order.

For this reason, a plurality of types of boxes of different standardized formats are usually prepared, which can be selected according to their capacity. For example, the most appropriate box format can be chosen in an automated manner, or by an operator, for example suggested by a visual system and/or through video instructions. In general, the boxes are made of cardboard and have a base wall and four lateral walls; possibly, they can already be partly pre-cut so as to have, respectively, four upper pre-cut panels connected to the respective lateral wall and substantially upright.

Nowadays, large e-commerce companies find themselves having to manage and process several thousand purchase orders per day relating to one or more objects at a time. Therefore, it becomes necessary to optimize the volume occupied by these objects in the respective box, resizing it appropriately (so-called “down-sizing”), both in order to reduce the consumption of filling material and also to make transport more efficient.

Sizing apparatuses capable of properly sizing boxes are known, which comprise one or more cutting devices provided with respective cutting members, such as shears, or cutters, to cut the vertical edges of the lateral walls of the box to a certain height, defining folding walls of a desired size, and with one or more creasing devices provided with respective creasing, or shaping, members to perform a horizontal creasing resizing along said lateral walls, so as to determine folding lines around which to rotate the folding walls and therefore finalize the desired resizing of the box, in a manner that is coordinated with the volume of the objects present in it.

In particular, in the event the cutting members are cutters, the cutting of the edges is performed from top to bottom, until the desired height is reached. Instead, in the event the cutting device is a shear, it is positioned on each occasion at a desired height, and acts separately on each vertical edge of the box.

One disadvantage of such known apparatuses is that often the cutting devices are quite bulky, and it is not possible to perform the simultaneous cutting of all the vertical edges. For example, in some known apparatuses the cutting is performed by two devices at a time, which are placed on opposite parts and sides of the box, that is, along a diagonal thereof. In addition, another disadvantage is that known apparatuses usually provide having boxes with a fixed base.

Another disadvantage of these known apparatuses is that, usually, the entire creasing operation is performed in a different zone from the cutting zone, since the overall dimensions of the cutting devices do not allow to place and move the creasing devices in the same zone.

Therefore, known apparatuses are often bulky and the process of sizing the box in order to package the objects can be laborious, slow and therefore inefficient, also in terms of the productivity required to package up to thousands of objects per day.

There is therefore the need to perfect an apparatus and a method for sizing a box containing one or more objects to be packaged, which can overcome at least one of the disadvantages of the state of the art.

To do this, it is necessary to solve the technical problem of speeding up the timings for cutting and creasing the boxes in order to resize them, optimizing the compactness of the apparatus and reducing the overall dimensions of the components used for sizing.

In particular, one purpose of the present invention is to provide an apparatus and develop a method for sizing a box containing one or more objects to be packaged, in which the cutting and at least one creasing part are performed in the same operating zone.

Another purpose of the present invention is to provide an apparatus and method that are highly efficient and that lead to optimizing resizing and packaging times.

Another purpose of the present invention is to provide an apparatus that is compact and has a high productivity.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes and to resolve the technical problem disclosed above in a new and original way, also achieving considerable advantages compared to the state of the prior art, the embodiments described here concern an apparatus for sizing a box, having lateral walls delimited by vertical edges and a horizontal base wall, and containing one or more objects.

The apparatus comprises a first frame, which is provided with a base configured to support a box, a resizing unit comprising a second frame configured to support a cutting and creasing unit, which comprises at least one cutting and creasing device having both a cutting member and also a creasing member which can be activated in a coordinated manner with each other. The at least one cutting and creasing device can slide on the second frame and be positioned at a predetermined height with respect to the base, in order to engage the box near to at least one of the vertical edges of the box.

In accordance with another aspect, the cutting member and the creasing member are closely placed and configured to be activated in a coordinated manner in order to perform both cutting and also creasing with a single movement, so that in an essentially simultaneous manner both a cutting line on a respective vertical edge of the box in a vertical direction, and also a creasing line on a respective one of the lateral walls of the box in a horizontal direction are created.

Doing so achieves the advantage that both the cutting and also the possibly partial creasing of the folding panels obtained from such cutting are performed with a single cutting and creasing device, thus reducing sizing times and making the apparatus compact.

In accordance with another aspect, the at least one cutting and creasing device comprises a first support part which can be entered into the box facing one of the vertical edges of the box, the first support part being provided with the cutting member and with a first creasing element of the creasing member, and a second support part which can be positioned outside and near to the box, the second support part being provided with a second creasing element of the creasing member and being configured to cooperate with the first creasing element to create the creasing line.

In accordance with another aspect, the first support part is pivoted to the second support part at an upper end thereof, and it is mobile from an open position away from the second support part to a closed position near to the second support part in order to create, essentially simultaneously, both the cutting line and also the creasing line on the box.

In accordance with another aspect, the cutting member comprises a shearing element configured to cooperate with a contrast member provided on the second support part to create the cutting line.

In accordance with another aspect, the shearing element is movable mounted on the first support part between a retracted position and an advanced position in which it protrudes from the first support part in order to cooperate with the contrast member so as to selectively perform cutting of the vertical edge.

In accordance with another aspect, the first creasing element is placed at a lower end of the first support part and comprises a creasing blade. The second creasing element is placed at a lower end of the contrast member and is provided with a first groove configured to receive the creasing blade in order to create the creasing line on the respective one of the lateral walls of the box.

In accordance with another aspect, the creasing member further comprises a creasing wheel placed at a lower end of the first support part and a contrast element placed at a lower end of the contrast member, the contrast element being provided with a second groove configured to engage and horizontally slide together with the creasing wheel in order to prolong the creasing line on the respective one of the lateral walls.

In accordance with another aspect, the apparatus further comprises, downstream of the resizing unit, a creasing unit selectively mobile both vertically to be placed at the predetermined height and also horizontally, and comprising a first and a second pair of engaging creasing rollers configured to perform, by means of a relative horizontal movement between the box and the creasing rollers, two opposite creasing lines on opposite lateral walls of the box, creating two additional opposite creasing lines.

In accordance with another aspect, the apparatus further comprises transport means cooperating with the base and configured to transport the box along a packaging path. The transport means comprise adjustable mobile elements which are adjustable in relation to the size of the box.

In accordance with another aspect, the cutting and creasing unit comprises a number of the cutting and creasing devices which is equal to the number of vertical edges of the box in order to perform, simultaneously and at the predetermined height, both cutting of all the vertical edges and also at least a portion of creasing lines on at least two opposite lateral walls of the box.

Further embodiments also concern a method for sizing a box having lateral walls delimited by vertical edges and a horizontal base wall, and containing one or more objects.

The method comprises the following steps:
positioning a box on a base of a first frame;
providing a resizing unit comprising a cutting and creasing unit which comprises at least one cutting and creasing device having both a cutting member and also a creasing member which can be activated in a coordinated manner with each other;
positioning the at least one cutting and creasing device at a predetermined height with respect to the base, near to a respective one of the vertical edges of the box;
cutting the respective one of the vertical edges of the box in a vertical direction, and
creasing at least one of the respective lateral walls of the box in a horizontal direction.

In accordance with another aspect of the present invention, the steps of cutting and creasing are selectively performed with a single movement and in an essentially simultaneous manner, by activating the cutting member and the creasing member in a coordinated manner, so that a cutting line on the respective one of the vertical edges of the box and a creasing line on one of the respective lateral walls of the box are created.

In accordance with another aspect, in the cutting and creasing steps, a first support part of the at least one cutting and creasing device, on which the cutting member and a first creasing element are mounted, is entered into the box facing a corresponding vertical edge, and a second support part of a same cutting and creasing device, comprising a contrast member, provided with a second creasing element, is positioned outside and near to the box. The first support part and the second support part are moved between each other from a distanced open position to a closed position, in order to perform the cutting and creasing steps. Moreover, the cutting step is carried out by a shearing element of the cutting member which cooperates with the contrast member, and the creasing step is carried out by a cooperation between the first and second creasing elements.

In accordance with another aspect, the shearing element is movable mounted on the first support part between a retracted position and an advanced position in which, during the cutting step, it protrudes from the first support part and cooperates with the contrast member.

In accordance with another aspect, the first creasing element is placed at a lower end of the first support part and comprises a creasing blade. The second creasing element is placed at a lower end of the contrast member and is provided with a first groove which receives the creasing blade during the creasing step.

In accordance with another aspect, the creasing member further comprises a creasing wheel placed at a lower end of the first support part and a contrast element placed at a lower end of the contrast member. The contrast element being provided with a second groove which engages and horizontally slides together with the creasing wheel during the creasing step to prolong the creasing line on the lateral wall.

In accordance with another aspect of the present invention, the method provides to operate a number of cutting and creasing devices coordinated with the number of edges of the box, which, in the cutting and creasing steps, are positioned at the predetermined height and simultaneously perform, with the single movement, both cutting of all the vertical edges, defining a respective number of folding panels, and also corresponding creasing on two opposite lateral walls of the box.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a lateral, schematic and partly sectioned view of an apparatus according to the present invention for sizing a box containing one or more objects to be packaged;

FIG. 2 is a schematic top view of the apparatus of FIG. 1 in a first operating condition, ready for a cutting step;

FIG. 3 is a schematic top view of the apparatus of FIG. 1 in a second operating condition, after a first creasing step has been completed;

FIG. 4 is a front, schematic and partly sectioned view of an apparatus according to the present invention, in which a second packaging zone is shown where the second creasing part occurs;

FIGS. from 5 to 7 are a schematic and detailed representation of a cutting and creasing step by means of a cutting and creasing device of the apparatus of FIG. 1;

FIGS. 8 and 9 are schematic representations, shown in a three-dimensional view from below, of a cutting and creasing device while it performs the cut and a corresponding creasing line along a smaller lateral wall of a box;

FIG. 10 is a lateral, schematic and partly sectioned view of an apparatus for sizing a pre-cut and pre-creased box containing one or more objects to be packaged, according to a variant with respect to FIG. 1.

We must clarify that the phraseology and terminology used in the present description, as well as the figures in the attached drawings also in relation as to how described, have the sole function of better illustrating and explaining the present invention, their purpose being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS

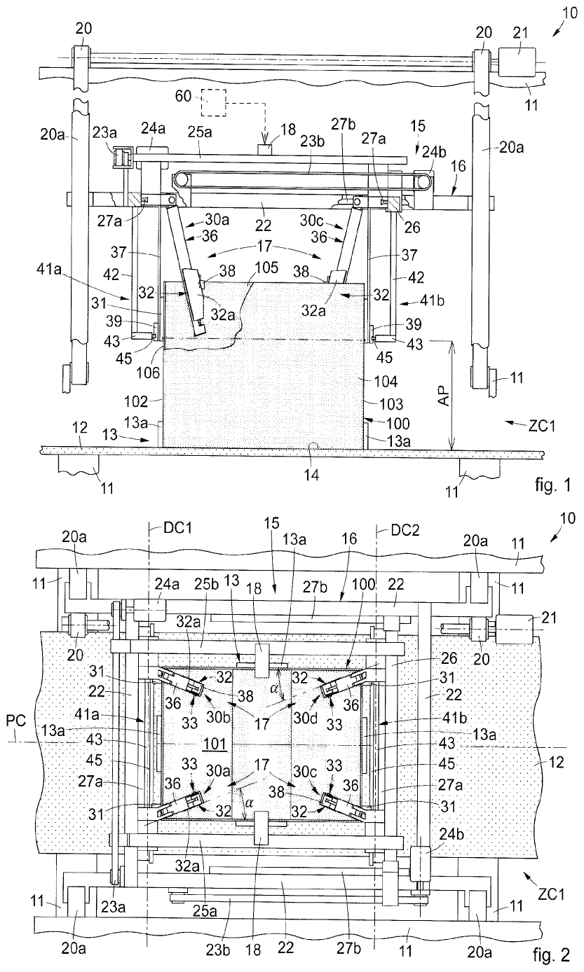

With reference to FIG. 1, some embodiments concern an apparatus 10 which can be used to perform work on a box 100 containing one or more objects to be packaged, in order to package such objects in said box 100, reducing the latter's volume as much as possible, subject to the sizes of the objects present therein, so as to save space.

Generally, the boxes 100 can have different sizes in relation to the shape and size of the objects that can be inserted inside them. Specifically, each box 100 comprises, for example, a bottom wall, or base wall, 101 defined by panels folded and associated with each other, a first and a second smaller lateral wall 102 and 103 (FIGS. 1 and 2) opposite each other, and a first and second larger lateral wall 104 and 105 opposite each other and perpendicular to the smaller lateral walls 102 and 103. The smaller and larger lateral walls 102-105 are interconnected by corresponding vertical edges, or borders, 106. Hereafter, the smaller and larger lateral walls 102-105 may also be referred to simply as lateral walls 102-105.

According to possible embodiments, the boxes 100 can be pre-cut at the vertical edges 106 and, therefore, provided with pre-cut panels 107 (FIG. 10) connected to the respective smaller and/or larger lateral wall 102-105 and substantially upright. It is not excluded, however, that the embodiments described here can also be used for sizing non pre-cut boxes 100. In addition, or alternatively, the boxes 100 can also be pre-creased, that is, they can be provided with one or more pre-creasing lines 108, each made at a corresponding height on the smaller and/or larger lateral walls 102-105.

In some embodiments, the apparatus 10 comprises a first fixed frame 11 (FIGS. from 1 to 3). The first fixed frame 11 can generally include a rest base 14 for the boxes 100 to be worked.

In some embodiments, the first frame 11 can be provided with a support and movement plane 12 for the boxes 100. The support and movement plane 12 can define the rest base 14. For example, the support and movement plane 12 can be defined by a plurality of idle rollers. We must clarify that, for illustrative clarity, the first frame 11 is only shown partly in the drawings.

With the support and movement plane 12 there can be associated transport means 13 which are configured to transport the corresponding box 100 along a packaging path PC, and which are adjustable in relation to the size or format of the boxes 100. In this way, the apparatus 10 is very versatile and is less sensitive to variations in the sizes of the boxes 100.

According to some embodiments, the transport means 13 can comprise mobile elements 13a (FIG. 1), such as for example transport teeth or levers, or pusher and counter pusher means, which can be adjusted to the size of the box 100 in order to hold it and then move it along the packaging path PC.

In further embodiments, the transport means can include an adjustable transport drawer 13b (FIG. 10), slidingly associated with the support and movement plane 12, in which a corresponding box 100 can be positioned. The transport drawer 13b can substantially have the shape of a parallelepiped and have a base that is adjustable as a function of the format of the box 100, so as to keep it stably positioned for cutting and creasing operations. The movement of the transport drawer 13b is determined by a corresponding drive member, of a known type and not shown in the drawings.

In some embodiments, the apparatus 10 comprises, at a first packaging zone ZC1, a resizing unit 15 (FIG. 1) configured to at least partly resize a box 100 in height, in relation to the size of the objects placed therein. The resizing unit 15 is associated with the first fixed frame 11 and configured to be placed in a desired operating position PO in order to perform the cut to size and at least a first creasing part or step on a box 100. In particular, the resizing unit 15 comprises a second mobile frame, or support and movement frame, 16 and cutting and creasing means, hereafter defined as cutting and creasing unit 17, associated therewith.

In some embodiments, the second mobile frame 16 can be operatively connected to the first frame 11 by means of one or more main movement members 20, such as belts, which have the function of selectively raising and lowering the second frame 16. The main movement members 20 are driven by at least one drive member 21.

In particular, the second frame 16, by means of the main movement members 20, is able to pass from a rest position PR to an operating position PO in order to take the cutting and creasing unit 17 to a desired predetermined height AP, so that the cutting of the vertical edges 106 is adapted to the size of the objects placed in the box 100.

It should be noted that the desired predetermined height AP is identified by starting from the base 14 on which the box 100 rests. This base 14 can be defined by the rest plane of the support and movement plane 12 (FIG. 1). Alternatively, the base 14 can be defined by the rest plane of the transport drawer 13 (FIG. 10).

In particular, detection means 18, schematized in FIGS. 1, 2, 3 and 10, for example ultrasonic, can be placed on the second frame 16 to automatically detect the format of the box 100 and the size of the objects placed therein, in particular their maximum height, in order to determine the predetermined height AP. We must clarify that the predetermined height AP is obtained by combining the maximum height of the object detected in the box 100 by the detection means 18 with the format of the latter. In addition, the detection means 18 can be operatively associated with the transport means 13, for example by providing sensors placed on the latter, so as to allow a correct and precise positioning of the cutting and creasing unit 17.

As can be seen in FIG. 1, vertical guides 20a connected to the first fixed frame 11 can be provided to guide the vertical movement of the second frame 16.

In some embodiments, the second frame 16 can comprise fixed perimeter elements 22 with which at least two secondary movement members 23a and 23b are associated, to move a first and second longitudinal rod 25a, 25b, and at least one transverse rod 26, respectively.

The two secondary movement members 23a and 23b can be driven by respective drive members 24a and 24b which are placed on corresponding fixed perimeter elements 22. In the example given here, the two secondary movement members 23a and 23b are defined by belts and are placed perpendicular to each other.

In some embodiments, the first and second longitudinal rod 25a, 25b are connected to the movement member 23a in order to slide perpendicularly to the packaging path PC and are placed opposing with respect to it; the transverse rod 26, on the other hand, is connected to the movement member 23b in order to slide along the packaging path PC and perpendicularly to the longitudinal rods 25a, 25b.

Furthermore, the two longitudinal rods 25a, 25b and the transverse rod 26 are guided, respectively, by guide elements 27a, 27b associated with corresponding fixed perimeter elements 22.

We must clarify that the displacements of the two longitudinal rods 25a, 25b and of the transverse rod 26 take place on respective sliding planes parallel to each other and to the support plane 12.

The two longitudinal rods 25a, 25b and the transverse rod 26 are configured to move the cutting and creasing unit 17 in order to place it precisely at the vertical edges 106 of a box 100 to be resized.

In accordance with some embodiments of the present invention, the cutting and creasing unit 17 comprises at least a first cutting and creasing device 30a, preferably also a second, a third and a fourth cutting and creasing device 30b, 30c, 30d, that is, a number coordinated with the number of vertical edges 106 of a box 100.

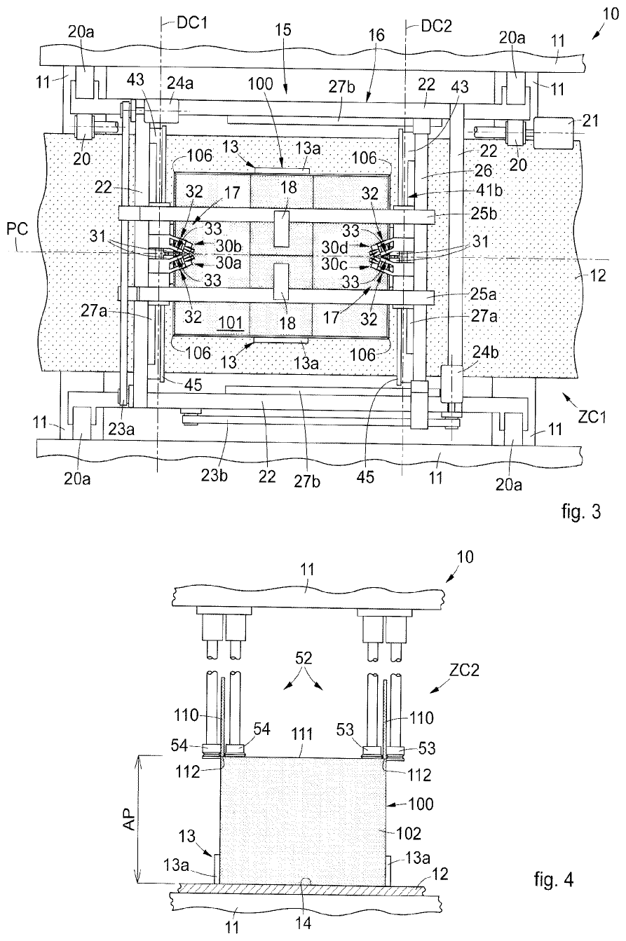

The first and second cutting and creasing device 30a and 30b can be placed on one side and on the other of the packaging path PC, in particular opposing with respect to each other, and aligned along a first creasing direction DC1 perpendicular to the latter. In the same way, the third and fourth cutting and creasing device 30c and 30d are also placed on one side and on the other of the packaging path PC, in particular opposing with respect to each other, and aligned along a second creasing direction DC2 perpendicular to the latter (FIGS. 1 and 3).

Specifically, the first and third cutting and creasing device 30a and 30c are attached to the first longitudinal rod 25a and aligned with each other, and the second and fourth cutting and creasing device 30b and 30d are attached to the second longitudinal rod 25b and aligned with each other. Therefore, the first and second longitudinal rod 25a, 25b, by sliding perpendicularly to the packaging path PC, have the function of selectively bringing closer to each other, or moving away from each other, the first and second cutting and creasing device 30a, 30b and, respectively, the third and fourth cutting and creasing device 30c, 30d, both in order to adapt the position of the cutting and creasing unit 17 to the format of the box 100, and also in order to perform the creasing on the first and second smaller lateral wall 102, 103, as will be described in detail below.

As can be observed in FIGS. 2 and 3, the cutting and creasing devices 30a-30d are oriented inward by a same anti-collision angle α with respect to the directions defined by the respective first and second longitudinal rod 25a, 25b to which they are attached. The anti-collision angle α is preferably comprised between about 30°, preferably between about 10° and about 20°. This allows the cutting and creasing devices 30a-30d to correctly perform the cutting of the vertical edges 106 and the first creasing step without interfering with the smaller and larger lateral walls 102-105 and/or without obstructing each other.

In addition, the third and fourth cutting and creasing device 30c, 30d are also associated with the transverse rod 26 which, by sliding along the packaging path PC, allows to take the third and fourth cutting and creasing device 30c, 30d closer, respectively, to the first and second cutting and creasing device 30a, 30b, thus following the length of the box.

In accordance with some embodiments, each cutting and creasing device 30a-30d comprises on board both a cutting member 32 and also first creasing means, hereafter defined as creasing member 33, which can be activated in a coordinated manner. The cutting member 32 has the function of suitably cutting corresponding vertical edges 106, thus defining corresponding folding panels 110 of the box 100 to be resized, and the creasing member 33 has the function of creating corresponding creasing lines 111 on the folding panels 110 connected to the first and second smaller lateral wall 102, 103.

Each creasing member 33 can comprise one or more first creasing elements 34 and one or more second creasing elements 35 configured to cooperate with each other to perform the creasing of the smaller lateral walls 102, 103.

In particular, each cutting and creasing device 30a-30d can be positioned at the desired predetermined height AP to engage at least one vertical edge 106, so as to perform, with a single movement and essentially simultaneously, both the cutting of a corresponding vertical edge 106 and also the beginning of the respective creasing line 111 in a horizontal direction along a respective smaller lateral wall 102, 103 of the box 100. In other words, the cutting member 32 and the creasing member 33 are closely placed and configured to be activated in a coordinated manner in order to perform both cutting and also creasing with a single movement, so that in an essentially simultaneous manner both a cutting line on a respective vertical edge 106 of the box 100 in a vertical direction, and also a creasing line 111 on a respective one of the lateral walls 102, 103, 104, 105 of the box 100 in a horizontal direction are created.

Each cutting and creasing device 30a-30d can comprise a first mobile support part 36, on which the cutting member 32 and the first creasing elements 34 are mounted on board, and a second support part 37 fixed with respect to the first support part 36, substantially vertical and comprising a contrast member 31 provided with the second creasing elements 35. In particular, the first support part 36 can be positioned inside, or entered into, the box 100 close to a corresponding vertical edge 106, and the second support part 37 can be positioned outside the box 100, so that the contrast member 31 tangentially contacts, or is placed close to, a corresponding external part of the box 100, and provide an abutment for the first support part 36.

Each second support part 37 can be provided externally with a respective coupling element 39 shaped in such a way as to have a guide recess 40 facing toward the outside.

Furthermore, in order to stabilize the movement of the cutting and creasing devices 30a-30d, the second frame 16 can also comprise a first and second support and guide system 41a and 41b placed perpendicularly to the packaging path PC and opposed with respect to the box 100, wherein the first support and guide system 41a is directly attached to the second frame 16 and the second support and guide system 41b is attached to the transverse rod 26 in order to move with it.

The first and second support and guide system 41a and 41b can each comprise two vertical rods 42 connected at the lower part by a transverse connection element 43. The connection element 43 is in turn provided with a guide protrusion 45 configured to cooperate with the guide recess 40 of the coupling elements 39.

Specifically, the first and second support and guide system 41a and 41b, by means of the respective connection elements 43, can be connected to the coupling elements 39 of the first and second cutting and creasing device 30a, 30b and, respectively, of the third and fourth cutting and creasing device 30c, 30d, in order to support them during the cutting operation and guide them during their movement in the first creasing step described above.

In some embodiments, the first support part 36 is pivoted to the second support part 37 at an upper end thereof, and it is mobile from an open position P1, in which it is away from, and inclined by a certain angle with respect to, the second support part 37 and, therefore, with respect to the contrast member 31, to a closed position P2, in which it is near to, and taken substantially against, the contrast member 31 and cooperates with it in order to perform the cutting of the vertical edge 106 and the beginning of the respective creasing line 111. For example, the closing and opening of the first support part 36 is determined by a drive member of known type and not shown in the drawings. For example, in the open position P1, the first support part 36 can be inclined with respect to the second support part 37 by an angle of about 10° and about 20°.

In accordance with some embodiments, the cutting member 32 comprises at least one shearing mean, hereafter defined as shearing element 32a, such as a shear or a die cutter, mounted externally on the first support part 36 and selectively mobile between a retracted position PT1, in which it does not protrude from the outline of the first support part 36, and an advanced position PT2, in which it is lowered protruding from the first support part 36 to be exposed toward the second support part 37 and, therefore, toward the contrast member 31, so as to perform the cutting of the vertical edges 106 when the first support part 36 passes into the closed position P2 (FIGS. 6 and 7).

In particular, the lowering of the cutting member 32 can occur by means of a respective guide and drive member 38, shown in simplified form in FIGS. 1 and from 5 to 7. The guide and drive member 38 is externally mounted on each first support part 36 and is configured to selectively lower and raise the shearing element 32a to cause the exposure of a part thereof which is able to perform the cutting of the respective vertical edge 106. For example, the guide and drive member 38 comprises an actuation member, such as a linear actuator, of a known type and not shown in the drawings.

In accordance with some embodiments, the first and second cutting and creasing device 30a, 30b and the third and fourth cutting and creasing device 30c, 30d can slide in the respective first and second creasing direction DC1, DC2, by means of the first and second longitudinal rod 25a and 25b (FIG. 3), so as to move reciprocally near to each other in order to at least partly create the respective creasing lines 111 on the smaller lateral walls 102, 103. In this condition, each first support part 36 is in the closed position P2 and each cutting member 32 is in the retracted position PT1.

We must clarify that by the expression “at least partly” we mean that creasing lines 111 are created which, in any case, have a sufficient length to allow the correct folding of the folding panels 110. In particular, the creasing lines 111 may not be completed in a central zone of the smaller lateral walls 102, 103 due to the overall dimensions of the cutting and creasing devices 30a-30d; however, even in this case, their length is such as to allow the folding of the folding panels 110.

The first creasing elements 34 can be placed at a lower, unconstrained end of the first support part 36 and comprise at least one creasing blade 46 (FIGS. from 5 to 9).

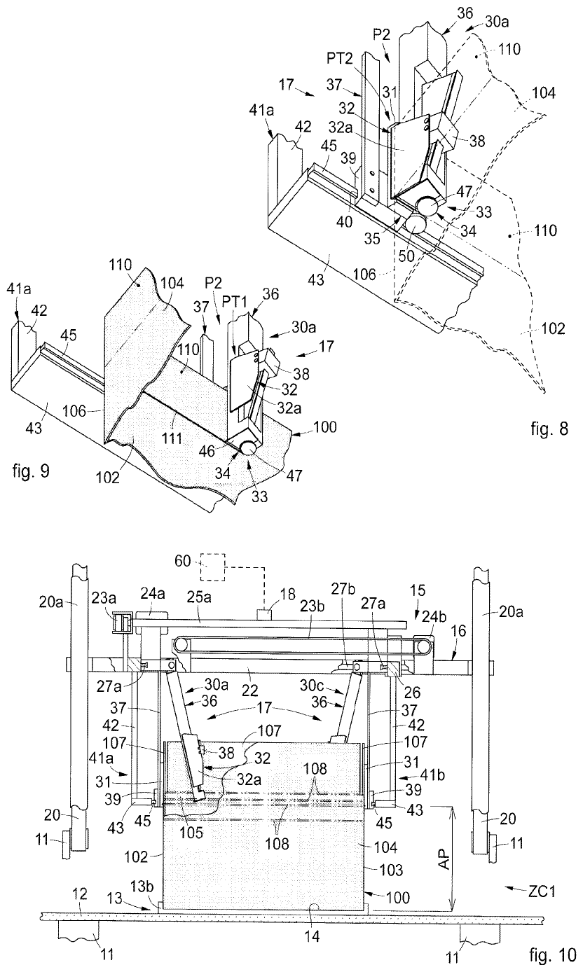

Moreover, in particular for boxes 100 of large formats, in addition to the creasing blade 46, the first creasing elements 34 cam also comprise a creasing wheel 47 (FIGS. 8 and 9) placed alongside the creasing blade 46 and aligned horizontally thereto in order to perform the creasing of the first and second smaller lateral wall 102, 103. This creasing wheel 47 can be mounted in an idle manner at the lower end of the first support part 36 (FIGS. 8 and 9), so as to be freely rotatable around an axis of rotation that is essentially vertical when the first support part 36 is in its closed position P2 close to a corresponding vertical edge 106, so as to create the desired horizontal creasing line.

The second creasing elements 35 can be placed at a lower end of the contrast member 31 so as to be horizontally aligned with the first creasing elements 34 to cooperate with them when the first support part 36 is in the closed position P2.

In particular, the second creasing elements 35 can comprise at least a first creasing seating, hereafter defined as first groove 49, able to cooperate with the creasing blade 46 to perform the creasing of the first and second smaller lateral wall 102, 103.

In addition, in the event that the creasing wheel 47 is also present, the second creasing elements 35 can also comprise a contrast element 50, for example a wheel, placed at a lower end of the contrast member 31 and having a second creasing seating, hereafter defined as second groove 51, which is horizontally aligned with the first groove 49 and able to cooperate with the creasing wheel 47 to prolong the creasing line 111 on the respective lateral wall 102, 103, 104, 105.

The first and second groove 49 and 51 can be configured so as to allow a partial and temporary insertion of a corresponding box 100 portion pushed by the creasing blade 46 and, respectively, by the creasing wheel 47 when the first support part 36 is in the closed position P2.

We must clarify that the end-of-travel of the first support part 36 when it passes into the closed position P2 can be defined by the sizing of the first creasing elements 34 and of the second creasing elements 35 present on the contrast member 31; in particular, by the sizing of the creasing blade 46 with respect to the depth of the first groove 49 and/or by the sizing of the creasing wheel 47 with respect to the depth of the second groove 51. This end-of-travel is particularly important for the correct execution of the cut of the vertical edges 106, since the cutting depth of the cutting member 32 also depends on it, when it is in the advanced position PT2.

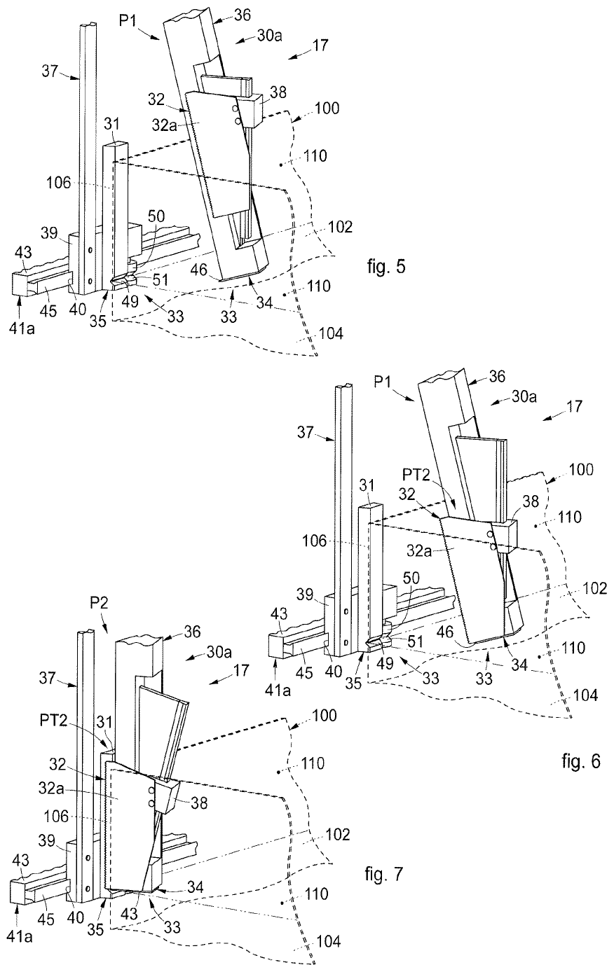

In some embodiments, the apparatus 10 also comprises, along the packaging path PC, a second packaging zone ZC2 (FIG. 4), in which there are placed, in sequence, at least first folding means, not shown in the drawings, second creasing means, hereafter defined as creasing unit 52, second folding means and means for closing the box 100, not shown in the drawings.

The first folding means are configured to fold the folding panels 110 connected to the first and second smaller lateral wall 102 and 103 toward the inside of the box 100, rotating them inward around the creasing lines 111 previously created, while the second folding means are configured to fold the folding panels 110 connected to the first and second larger lateral wall 104 and 105 inward, also in this case rotating them inward around the respective creasing lines 112.

We must clarify that the folding of the folding panels 110 and the subsequent closing of the box 100, for example by taping, can, for example, be performed as disclosed in the Italian patent application no. 102021000014867 filed in the name of the Applicant.

The creasing unit 52 can be associated, in a manner not shown in the drawings, with the first fixed frame 11 and positioned above the support plane 12 along the packaging path PC of the box 100. The creasing unit 52 is selectively mobile both vertically to be placed at the desired predetermined height AP, and also perpendicularly to the packaging path PC in order to adapt to the format of the box 100.

In particular, the creasing unit 52 can comprise a first and a second pair of engaging creasing rollers 53 and 54, which are placed on one side and on the other with respect to the packaging path PC, in particular opposing each other and configured to perform, by means of a relative movement between them and the box 100, the creasing on the opposite first and second larger wall 104 and 105, making further opposite creasing lines 112, which are aligned with those created by the creasing member 33 and which allow to suitably fold the corresponding folding panels 110.

We must clarify that the above mentioned relative movement between the creasing unit 52 and the box 100 can be coordinated with a relative movement of the box 100 with respect to the creasing unit 52 which remains fixed, or vice versa.

In possible implementations, the creasing rollers 53 and 54 of each pair are placed coupled, that is, side by side to each other, and at a distance such as to allow the passage of respective folding flaps 110, printing corresponding creasing marks on them which define the further opposite creasing lines 112.

In possible embodiments, the apparatus 10 further comprises a central control unit 60 (FIGS. 1 and 10) operatively connected to the detection means 18 and programmed to drive the resizing unit 15, in particular the cutting and creasing unit 17, the creasing unit 52 and the folding means to perform the cutting and creasing of the lateral walls of the box 100.

We must clarify that in the event that the boxes 100 are provided with pre-cut panels 107 (FIG. 10), the resizing unit 15 can also be provided with stabilization and straightening means, not shown in the drawings, which are configured to stabilize the pre-cut panels 107 and keep them in a substantially upright position for the correct placement of the cutting and creasing devices 30a-30d and the correct execution of the cut by means of the cutting members 32.

Some embodiments of a method for sizing boxes 100 are described below, in relation to the operation of the apparatus 10 described heretofore.

In particular, in an initial preparation step, the central control unit 60 is programmed to control and coordinate the activation of the drive members to drive the apparatus 10, in particular the means for transporting the box 100, the resizing unit 15, the first and second folding means and the creasing unit 52.

In a subsequent step of coordinated placement, the objects are placed, in a known manner, in a respective box 100, the format of which is chosen according to the size of the objects themselves. Furthermore, the box 100 is positioned on the base 14 at the first packaging zone ZC1 (FIG. 1).

In this step, the detection means 18 detect the format of the box 100 and the size of the objects present therein, in particular the greatest height thereof, and the predetermined height AP at which to place the cutting and creasing devices 30a-30d with respect to the base 14 is determined by means of the central control unit 60.

Then, the resizing unit 15 is activated and arranged to allow the sizing of the box 100. Furthermore, the cutting and creasing devices 30a-30d are activated in order to place the first support part 36 in the open position P1, in which it is away from the second support part 37.

Subsequently, a step of cutting and creasing the box 100 begins in which, in relation to the format of the box 100 and the predetermined height AP, the resizing unit 15 is lowered into the desired operating position PO and the two longitudinal rods 25a, 25b and the transverse rod 26 are moved in order to place each cutting and creasing device 30a-30d at the respective vertical edges 106. In particular, the cutting and creasing devices 30a-30d are placed at the predetermined height AP with respect to the base 14, with the first support part 36 positioned inside, or entered into, the box 100 and the second support part 37 outside the box 100, so that the contrast member 31 is in contact with, or close to, a corresponding external zone of the box 100.

Then, each cutting member 32 (FIG. 5) is lowered into the advanced position PT2 (FIG. 6) so as to protrude from the first support part 36 and be exposed toward the second support part 37, that is, toward the contrast member 31.

Then the first support part 36 is taken into the closed position P2 (FIG. 7) and with this movement it performs, in an essentially simultaneous manner, both the cutting of a corresponding vertical edge 106 by means of the cutting member 32, and also the beginning of the creasing line 111 of the respective first and second smaller lateral wall 102, 103 by means of the creasing member 33. In particular, with this single movement, that is, by taking the first support part 36 into the closed position P2, each shearing element 32a cuts the corresponding vertical edge 106 in a vertical direction, creating a corresponding number of folding panels 110, and the first creasing elements 34 push a corresponding portion of the box 100 against the second creasing elements 35, starting the respective creasing line 111.

Subsequently, in a first creasing step, the first support part 36 is in the closed position P2 (FIGS. 8 and 9), the cutting member 32, that is, the shearing element 32a, is in the retracted position PT1, and by means of the approaching movement between the two longitudinal rods 25a and 25b, the first and second cutting and creasing device 30a, 30b and the third and fourth cutting and creasing device 30c, 30d slide horizontally in the first and second creasing direction DC1 and DC2, moving reciprocally closer to each other and creating the corresponding horizontal creasing lines 111 on the first and second smaller lateral wall 102, 103.

We must clarify that, in the event that the boxes 100 are provided with the pre-creasing lines 108, the last operation is not necessary, and the predetermined height AP will substantially coincide with a pre-creasing line 108 positioned immediately above the desired height, calculated by taking into account the maximum height of the objects present in the box 100 and the format of the latter.

Once the first creasing step is finished, by means of the transport means 13, the box 100 is made to advance along the packaging path PC to take it at the second packaging zone ZC2 (FIG. 4) in which, initially, the first folding means fold, in a known manner, the folding panels 110 connected to the first and second smaller lateral wall 102, 103 of the box 100 inward.

Thereafter, the box 100 is taken at the creasing unit 52 to perform the second creasing step in which, initially, the first and second pair of creasing rollers 53 and 54 are moved horizontally so as to be adapted to the format of the box 100 and placed vertically at the predetermined height AP.

Subsequently, with a relative movement between the creasing unit 52 and the box 100, the folding panels 110 connected to the first and second larger lateral wall 104 and 105 pass between the creasing rollers 53 and 54 of each pair, which print corresponding creasing marks on them, defining further horizontal creasing lines 112.

Once the second creasing part is completed, the second folding means fold the folding panels 110 connected to the first and second larger lateral wall 104 and 105 and the box 100 is taken by the transport means 13 toward the closing means. Then, in a subsequent closing step, for example by taping, the box 100 is closed and prepared for labeling and/or shipping.

It is clear that modifications and/or additions of parts or steps may be made to the apparatus 10 and to the method as described heretofore, without departing from the field and scope of the present invention, as defined by the claims.

It is also clear that, although the present invention has been described with reference to some specific examples, a person of skill in the art will be able to achieve other equivalent forms of sizing apparatuses, having the characteristics as set forth in the claims and hence all coming within the field of protection defined thereby.

In the following claims, the sole purpose of the references in brackets is to facilitate their reading and they must not be considered as restrictive factors with regard to the field of protection of the same claims.

1. Apparatus for sizing a box having lateral walls delimited by vertical edges and a horizontal base wall, and containing one or more objects, said apparatus comprising a first frame, which is provided with a base configured to support a box, a resizing unit comprising a second frame configured to support a cutting and creasing unit which comprises at least one cutting and creasing device having both a cutting member and also a creasing member which can be activated in a coordinated manner with each other, wherein said at least one cutting and creasing device can slide on the second frame and be positioned at a predetermined height with respect to said base in order to engage said box near to a respective one of the vertical edges of said box, wherein said cutting member and said creasing member are closely placed and configured to be activated in a coordinated manner in order to perform both cutting and also creasing with a single movement, so that in an essentially simultaneous manner both a cutting line on a respective vertical edge of the box in a vertical direction and also a creasing line on a respective one of said lateral walls of said box in a horizontal direction are created.

2. Apparatus as in claim 1, wherein said at least one cutting and creasing device comprises a first support part which can be entered into said box facing one of the vertical edges of the box, said first support part being provided with said cutting member and with a first creasing element of said creasing member, and a second support part which can be positioned outside and near to said box, said second support part being provided with a second creasing element of said creasing member and being configured to cooperate with the first creasing element to create said creasing line.

3. Apparatus as in claim 2, wherein said first support part is pivoted to said second support part at an upper end thereof and is mobile from an open position away from the second support part to a closed position near to the second support part to create essentially simultaneously both said cutting line and also said creasing line on the box.

4. Apparatus as in claim 2, wherein said cutting member comprises a shearing element configured to cooperate with a contrast member provided on said second support part to create said cutting line.

5. Apparatus as in claim 4, wherein said shearing element is movable mounted on said first support part between a retracted position and an advanced position in which it protrudes from said first support part in order to cooperate with said contrast member so as to selectively perform cutting of the vertical edge.

6. Apparatus as in claim 4, wherein said first creasing element is placed at a lower end of said first support part and comprises a creasing blade, and said second creasing element is placed at a lower end of said contrast member and is provided with a first groove configured to receive said creasing blade in order to create said creasing line on the respective one of said lateral walls of the box.

7. Apparatus as in claim 4, wherein said creasing member further comprises a creasing wheel placed at a lower end of said first support part and a contrast element placed at a lower end of said contrast member, said contrast element being provided with a second groove configured to engage and horizontally slide together with said creasing wheel in order to prolong the creasing line on the respective one of said lateral walls.

8. Apparatus as in claim 1, further comprising downstream of said resizing unit, a creasing unit selectively mobile both vertically to be placed at said predetermined height and also horizontally, and comprising a first and a second pair of engaging creasing rollers configured to perform, by means of a relative horizontal movement between said box and said creasing rollers, two opposite creasing lines on opposite lateral walls of said box, creating two additional opposite creasing lines.

9. Apparatus as in claim 1, further comprising transport means cooperating with said base and configured to transport the box along a packaging path, and said transport means comprise adjustable mobile elements which are adjustable in relation to the size of said box.

10. Apparatus as in claim 1, wherein said cutting and creasing unit comprises a number of said cutting and creasing devices which is equal to the number of vertical edges of said box in order to perform, simultaneously and at said predetermined height, both cutting of all the vertical edges, and also at least a portion of creasing lines on at least two opposite lateral walls of the box.

11. Method for sizing a box having lateral walls delimited by vertical edges and a horizontal base wall, and containing one or more objects, said method comprising:
positioning a box on a base of a first frame;
providing a resizing unit comprising a cutting and creasing unit which comprises at least one cutting and creasing device having both a cutting member and also a creasing member which can be activated in a coordinated manner with each other;
positioning said at least one cutting and creasing device at a predetermined height with respect to said base, near to a respective one of the vertical edges of said box;
cutting said respective one of the vertical edges of said box in a vertical direction, and
creasing at least a respective one of the lateral walls of said box in a horizontal direction,
wherein
said steps of cutting and creasing are selectively performed with a single movement and in an essentially simultaneous manner, by activating in a coordinated manner said cutting member and said creasing member, so that a cutting line on said respective one of the vertical edges of the box and a creasing line on one of the respective lateral walls of said box are created.

12. Method as in claim 11, wherein in said cutting and creasing steps, a first support part of said at least one cutting and creasing device, on which said cutting member and a first creasing element are mounted, is entered into said box facing a corresponding vertical edge, and a second support part of a same cutting and creasing device, comprising a contrast member, provided with a second creasing element, is positioned outside and near to said box, in that said first support part and said second support part are moved between each other from a distanced open position to a closed position to perform both said cutting and creasing steps, and said cutting step is carried out by a shearing element of said cutting member which cooperates with said contrast member, and said creasing step is carried out by a cooperation between said first and second creasing elements.

13. Method as in claim 12, wherein said shearing element is movable mounted on said first support part between a retracted position and an advanced position, in which, during the cutting step, it protrudes from said first support part and cooperates with said contrast member.

14. Method as in claim 12, wherein said first creasing element is placed at a lower end of said first support part and comprises a creasing blade, and in that said second creasing element is placed at a lower end of said contrast member and is provided with a first groove which receives said creasing blade during said creasing step.

15. Method as in claim 12, wherein said creasing member further comprises a creasing wheel placed at a lower end of said first support part and a contrast element placed at a lower end of said contrast member, said contrast element being provided with a second groove which engages and horizontally slides together with said creasing wheel during the creasing step to prolong the creasing line on the lateral wall.

16. Method as in claim 11, wherein the method provides to operate a number of cutting and creasing devices coordinated with the number of edges of said box, which, in said cutting and creasing steps, are positioned at said predetermined height and simultaneously perform, with said single movement, both cutting of all the vertical edges, defining a respective number of folding panels, and also corresponding creasing on two opposite lateral walls of the box.
